(19) United States
(12) Patent Application Publication
(10) Pub. No.: US 2014/0306610 A1
(43) Pub. Date: Oct. 16, 2014

(54) ELECTRONIC DEVICE AND METHOD FOR ADJUSTING LIGHT SOURCE IN AUTOMATIC OPTIC INSPECTION PROCESS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: GUANG-JIAN WANG, Shenzhen (CN)

(21) Appl. No.: 13/922,287

(22) Filed: Jun. 20, 2013

(30) Foreign Application Priority Data
Apr. 15, 2013 (CN) 2013101293109

(51) Int. Cl. H05B 33/08

(52) U.S. Cl. CPC H05B 33/0854
USPC 315/149

(57) ABSTRACT

In a method for adjusting a light source in an automatic optic inspection process, a light source is controlled to irradiate a testing platform, the testing platform fixing a test object in the automatic optic inspection process. An image capturing device is controlled to capture images of the reference object when the reference object moves among corners of the testing platform, and an average brightness of each captured image is computed when the captured images are obtained from the image capturing device. A number of pixels in each predefined brightness section of each captured image is recorded if the average brightness of all the captured images are equal, and the light source is adjusted such that numbers of the pixels in a predefined brightness section of each captured image are equal if the numbers of the pixels in the predefined brightness section of each captured image are not equal.

### BACKGROUND

1. Technical Field

The embodiments of the present disclosure relate to light source adjusting systems and methods, and more particularly to an electronic device and method for adjusting a light source in an automatic optic inspection process.

2. Description of Related Art

In recent years, when using an automatic optic inspection (AOI) equipment to make an automatic optic inspection of an image of a test object, such as a PCB board, an X-Y platform may be used to fix the test object such light irradiated by a light source is completely parallel to the test object. However, fixing the test object using the X-Y platform takes too much time and is too expensive.

### BRIEF DESCRIPTION OF THE DRAWINGS

FIG. 1 is a block diagram of one embodiment of an electronic device including a light source adjusting system.

FIG. 2 is a block diagram of one embodiment of function modules of the light source adjusting system in FIG. 1.

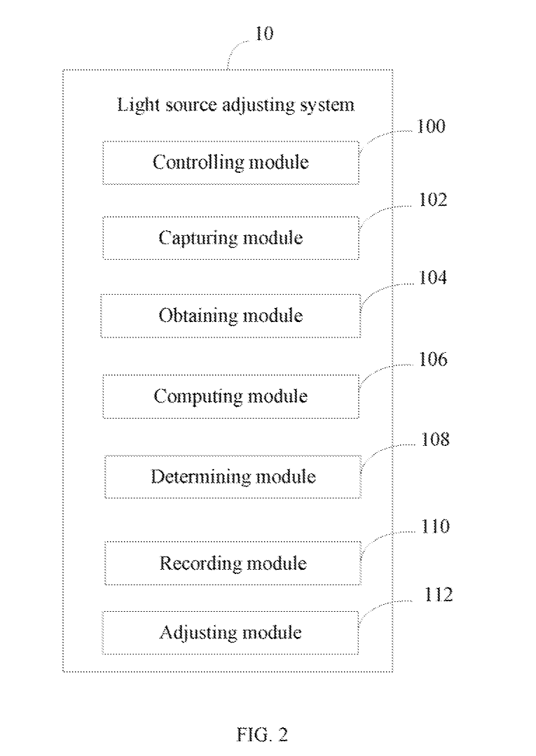

FIG. 3 is a flowchart of one embodiment of a method for adjusting light source in automatic optic inspection process.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

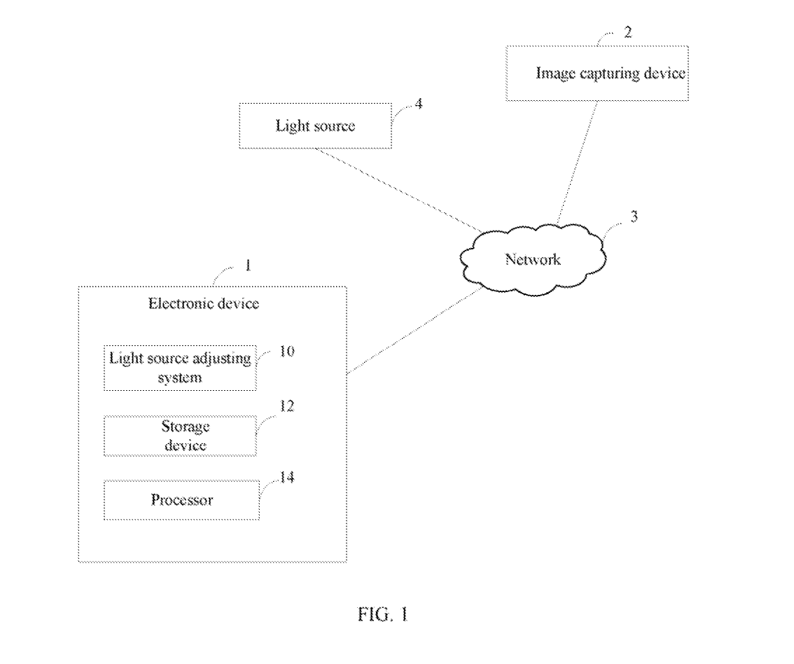

FIG. 1 is a block diagram of one embodiment of an electronic device 1 including a light source adjusting system 10. In the embodiment, the electronic device 1 connects to an image capturing device 2 and a light source 4 through a network 3. The electronic device 1 comprises a storage device 12, at least one processor 14 The electronic 1 may be a personal computer, a server, a personal digital assistant (PDA) device, or a tablet computer, for example. The network 3 is a wired or wireless network.

In one embodiment, the storage device 12 (e.g., a non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a non-transitory storage medium.

At least one processor 14 may include a processor unit, a microprocessor, an application-specific integrated circuit, and a field programmable gate array, for example.

The image capturing device 2 captures a plurality of images of a reference object when the reference object is being moved among corners of a testing platform in real time. In the embodiment, the reference object may be a metal block. The testing platform is used to fix a test object, such as a PCB board, in an automatic optic inspection process.

The light source 4 may be an LED light source that can be controlled by an electronic power. The light source 4 has several LED units, and each LED unit is a LED light.

In one embodiment, the light source adjusting system 10 includes a plurality of function modules which include computerized codes or instructions that can be stored in the storage device 12 and executed by the at least one processor 14 to provide a method for adjusting light source in automatic optic inspection process.

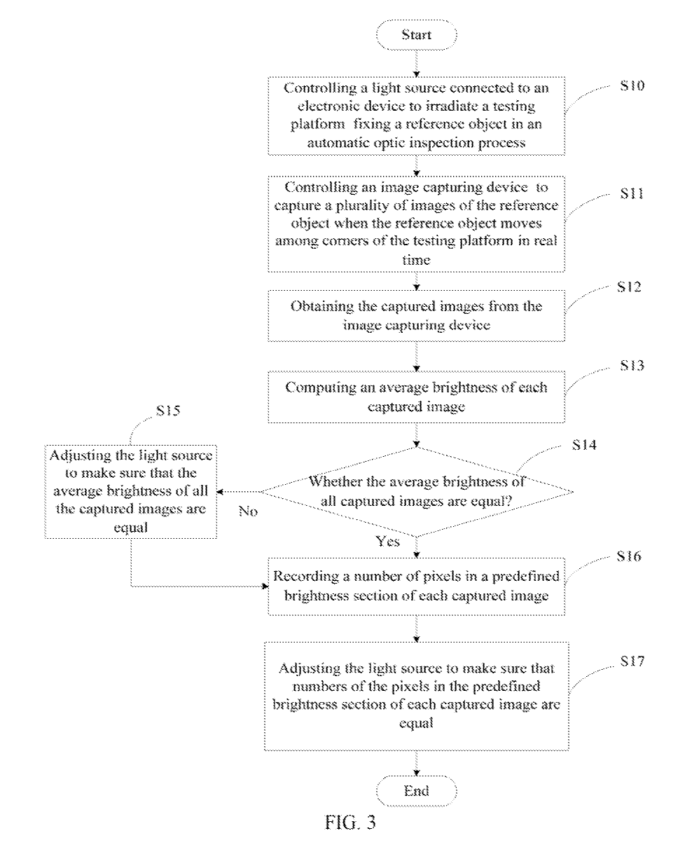

In one embodiment, the light source adjusting system 10 may include a controlling module 100, a capturing module 102, an obtaining module 104, a computing noticing module 106, a determining module 108, a recording module 110, and an adjusting module 112. The modules may comprise computerized codes in the form of one or more programs that are stored in the storage device 12 and executed by the at least one processor 14 to provide functions for implementing the modules. The functions of the function modules are illustrated in FIG. 3 and described below.

FIG. 3 illustrates a flowchart of one embodiment of a method for adjusting light source in automatic optic inspection. Depending on the embodiment, additional steps may be added, others removed, and the ordering of the steps may be changed.

In block S10, the controlling module 100 controls the light source 4 to irradiate the testing platform with light, the testing platform fixing a reference object in an automatic optic inspection process.

In block S11, the capturing module 102 controls the image capturing device 2 to capture a plurality of images of the reference object when the reference object moves among corners of the testing platform in real time.

In block S12, the obtaining module 104 obtains the captured images from the image capturing device 2.

In block S13, the computing module 106 computes an average brightness of each captured image. In the embodiment, the average brightness of each captured image can be computed as follows: the average brightness of each captured image=(R+G+B)/N, where R (Red) is a sum of red brightness of all pixels of each captured image, G (Green) is a sum of green brightness of all pixels of each captured image, B (Blue) is a sum of blue brightness of all pixels of each captured image, and N is a number of the pixels of each captured image.

In block S14, the determining module 108 determines whether the average brightness of all captured images are equal. If the average brightness of all captured images are equal, S16 is implemented. If the average brightness of all captured images are not equal, S15 is implemented.

In block S15, the adjusting module 112_adjusts the light source 4 such that the average brightness of all the captured images are equal. In the embodiment, pieces of gauze is covered onto the light source 4. The average brightness of all the captured images may be adjusted by adding or reducing a thickness of the gauze covered onto the light source 4. For example, the thickness of the gauze is added where is more bright on the light source 4, and is reduced where is less bright on the light source, such that the average brightness of all the captured images are equal.

In block S16, a recording module 110 records a number of the pixels in each predefined brightness section of each captured image. In the embodiment, the predefined brightness section may be selected from four brightness sections of [0-50], [51-150], [151-180], and [180-255]. The each captured image may be recognized by Open Source Computer Vision Library (Open CV), and the number of the pixels in each of the four predefined brightness section is recorded.

In block S17, the adjusting module 112 adjusts the light source 4 such that the numbers of the pixels in each predefined brightness section of each captured image are equal, if the numbers of the pixels in the predefined brightness section of each captured image are not equal. And if the numbers of the pixels in each predefined brightness section of each captured image are equal, the flow of the method is ended. In the embodiment, the light source 4 is an LED light source which can be controlled by an electrical power. The light source 4 has several LED units, and each LED unit is a LED light. Each LED unit can be controlled by adding or reducing an outputted voltage such that the numbers of the pixels in each predefined brightness section of each captured image are equal, so as to the light irradiated by the light source 4 is completely parallel to the testing platform.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one processor; and
a storage device storing one or more programs, which when executed by the at least one processor, causes the at least one processor to:
control a light source connected to the electronic device to irradiate a testing platform with light, the test platform fixing a test object in an automatic optic inspection process;
control an image capturing device connected to the electronic device to capture a plurality of images of a reference object when the reference object moves among corners of the testing platform in real time;
obtain the captured images from the image capturing device;
compute an average brightness of each captured image;
determine whether the average brightness of all the captured images are equal;
adjust the light source such that the average brightness of all the captured images are equal, if the average brightness of all the captured images are not equal;
record a number of pixels in a predefined brightness section of each captured image, if the average brightness of all the captured images are equal; and
adjust the light source such that numbers of the pixels in the predefined brightness section of each captured image are equal, if the numbers of the pixels in the predefined brightness section of each captured image are not equal.

2. The electronic device according to claim 1, wherein the average brightness of each captured image is computed as follows:
the average brightness=(R+G+B)/N, wherein R (Red) is a sum of red brightness of all pixels of each captured image, G (Green) is a sum of green brightness of all pixels of each captured image, B (Blue) is a sum of blue brightness of all pixels of each captured image, and N is a number of the pixels of each captured image.

3. The computing device according to claim 1, the average brightness of all the captured images are adjusted by adding or reducing a thickness of a gauze covering the light source such that the average brightness of all the captured images are equal.

4. The computing device according to claim 1, wherein the predefined brightness sections are selected from four brightness sections of [0-50], [51-150, [151-180], and [180-255] brightness.

5. The computing device according to claim 1, wherein the light source is an LED light source having a plurality of LED units.

6. The computing device according to claim 5, wherein each of the LED units is an LED light controlled by different outputted voltages such that the numbers of the pixels in each predefined brightness section of each captured image are equal such that the light irradiated by the light source is completely parallel to the testing platform.

7. A method for adjusting a light source in an automatic optic inspection process, the method comprising:
controlling a light source connected to the electronic device to irradiate a testing platform with light, the test platform fixing a test object in an automatic optic inspection process;
controlling an image capturing device connected to the electronic device to capture a plurality of images of the reference object when the reference object moves among corners of the testing platform in real time;
obtaining the captured images from the image capturing device;
computing an average brightness of each captured image;
determining whether the average brightness of all the captured images are equal;
adjusting the light source such that the average brightness of all the captured images are equal if the average brightness of all the captured images are not equal;
recording a number of pixels in a predefined brightness section of each captured image if the average brightness of all the captured images are equal; and
adjusting the light source such that numbers of the pixels in the predefined brightness section of each captured image are equal, if the numbers of the pixels in the predefined brightness section of each captured image are not equal.

8. The method according to claim 7, wherein the average brightness of each captured image is computed as follows:
the average brightness=(R+G+B)/N, wherein R (Red) is a sum of red brightness of all pixels of each captured image, G (Green) is a sum of green brightness of all pixels of each captured image, B (Blue) is a sum of blue brightness of all pixels of each captured image, N is a number of the pixels of each captured image.

9. The method according to claim 7, wherein the average brightness of all the captured images are adjusted by adding or reducing a thickness of a gauze covering the light source such that the average brightness of all the captured images are equal.

10. The method according to claim 7, wherein the predefined brightness sections are selected from four brightness sections of [0-50], [51-150], [151-180], and [180-255] brightness.

11. The method according to claim 7, wherein the light source is an LED light source having a plurality of LED units.

12. The method according to claim 11, wherein each LED unit is a LED light which is controlled by different outputted voltages such that the numbers of the pixels in each predefined brightness section of each captured image are equal such that the light irradiated by the light source is completely parallel to the testing platform.

13. A non-transitory computer-readable storage medium having stored thereon instructions being executed by a processor of an electronic device, causes the electronic device to perform a method for adjusting a light source in an automatic optic inspection, the method comprising:
controlling a light source connected to the electronic device to irradiate a testing platform with light, the test platform fixing a test object in an automatic optic inspection process;
controlling an image capturing device connected to the electronic device to capture a plurality of images of the reference object when the reference object moves among corners of the testing platform in real time;
obtaining the captured images from the image capturing device;
computing an average brightness of each captured image;
determining whether the average brightness of all the captured images are equal;
adjusting the light source such that the average brightness of all the captured images are equal if the average brightness of all the captured images are not equal;
recording a number of pixels in a predefined brightness section of each captured image if the average brightness of all the captured images are equal; and
adjusting the light source such that numbers of the pixels in the predefined brightness section of each captured image are equal, if the numbers of the pixels in the predefined brightness section of each captured image are not equal.

14. The storage medium according to claim 13, wherein the average brightness of each captured image is computed as follows:
the average brightness=(R+G+B)/N, wherein R (Red) is a sum of red brightness of all pixels of each captured image, G (Green) is a sum of green brightness of all pixels of each captured image, B (Blue) is a sum of blue brightness of all pixels of each captured image, N is a number of the pixels of each captured image.

15. The storage medium according to claim 13, wherein the average brightness of all the captured images are adjusted by adding or reducing a thickness of a gauze covering the light source such that the average brightness of all the captured images are equal.

16. The storage medium according to claim 13, wherein the predefined brightness sections are selected from four brightness sections of [0-50], [51-150], [151-180], and [180-255] brightness.

17. The storage medium according to claim 13, wherein the light source is an LED light source having a plurality of LED units.

18. The storage medium according to claim 17, wherein each LED unit is a LED light which is controlled by different outputted voltages such that the numbers of the pixels in each predefined brightness section of each captured image are equal such that the light irradiated by the light source is completely parallel to the testing platform.
